(19) United States
(12) Patent Application Publication
(10) Pub. No.: US 2017/0292381 A1
(43) Pub. Date: Oct. 12, 2017

(54) EXHAUST TURBINE FOR TURBOCHARGER

(71) Applicant: DENSO CORPORATION, Kariya-city, Aichi-pref (JP)

(72) Inventor: Mikito ISHII, Kariya-city (JP)

(21) Appl. No.: 15/508,645

(22) PCT Filed: Sep. 1, 2015
(86) PCT No.: PCT/JP2015/004442

§ 371 Date: Mar. 3, 2017

(30) Foreign Application Priority Data
Sep. 4, 2014 (JP) 2014-180610
Aug. 28, 2015 (JP) 2015-168824

(51) Int. Cl. F01D 5/04; F01D 9/02; F01D 25/24

(52) U.S. Cl. CPC F01D 5/048; F01D 25/24; F01D 9/026; F05D 2220/40; F05D 2240/12

(57) ABSTRACT

Different attack angles including a first attack angle and a second attack angle are set to turbine blades on a first axial side and a second axial side according to respective relative inflow angles of an exhaust gas. In other words, the first attack angle is set on the first axial side according to a relative inflow angle of an exhaust gas blown against the turbine blades through a first scroll passage, and the second attack angle is set on the second axial side according to a relative inflow angle of an exhaust gas blown against the turbine blades through a second scroll passage. An average value of the first attack angle is larger than an average value of the second attack angle.

### CROSS REFERENCE TO RELATED APPLICATION

This application is based on Japanese Patent Application No. 2014-180610 filed on Sep. 4, 2014 and Japanese Patent Application No. 2015-168824 filed on Aug. 28, 2015, the disclosures of which are incorporated herein by reference.

### TECHNICAL FIELD

The present disclosure relates to an exhaust turbine used for a turbocharger and including two scroll passages each having a different capacity.

### BACKGROUND ART

An exhaust turbine for a turbocharger in the related art is disclosed in Patent Literature 1.

The exhaust turbine disclosed in Patent Literature 1 includes a first scroll passage having a small passage area and a second scroll passage having a large passage area which are defined by dividing an interior of a turbine housing in an axial direction by a partition wall, and a variable capacity valve capable of opening and closing an inlet of the second scroll passage.

The exhaust turbine is capable of obtaining a turbine output corresponding to a flow rate of an exhaust gas by, for example, closing the variable capacity valve in a low-speed rotation range of an engine (for example, when a flow rate of an exhaust gas is low) to intensively introduce an exhaust gas into the first scroll passage alone and by opening the variable capacity valve in a high-speed rotation range where a flow rate of an exhaust gas is high to introduce an exhaust gas also into the second scroll passage.

### PRIOR ART LITERATURES

### Patent Literature

Patent Literature 1: JPS58-138222A

### SUMMARY OF INVENTION

In the exhaust turbine disclosed in Patent Literature 1, however, the first scroll passage and the second scroll passage have different passage areas. To be more specific, a passage area of the first scroll passage accounts for one third or less of an entire area. Hence, according to the disclosed configuration, two different flow rates and two different velocity vectors are generated in the axial direction at an inlet of turbine blades and a flow of an exhaust gas from each scroll passage flows into the turbine blades at different angles. The inventor conducted a detailed study and discovered that in a case where the turbine blades are designed to introduce an exhaust gas into both of the first scroll passage and the second scroll passage, a problem arises when an exhaust gas is introduced into the first scroll passage alone because turbulence or choking occurs and a pressure loss increases to an extent that turbine efficiency deteriorates. The inventor discovered another problem that a frictional loss on a passage surface increases in the first scroll passage having a small passage area in comparison with the second scroll passage having a large passage area, and such an increase in frictional loss deteriorates turbine efficiency.

An object of the present disclosure is to provide an exhaust turbine used for a turbocharger and capable of restricting deterioration of turbine efficiency.

According to an aspect of the present disclosure, the exhaust turbine applied to a turbocharger includes a turbine wheel having a plurality of turbine blades on a periphery of a hub fixed to a shaft, and a turbine housing defining a scroll passage on an outer periphery of the turbine wheel. The turbine wheel rotates when an exhaust gas discharged from an internal combustion engine is blown against the turbine blades through the scroll passage. The turbine housing divides the scroll passage into a first axial side and a second axial side to provide a first scroll passage on the first side and a second scroll passage on the second side in such a manner that a flow rate of an exhaust gas blown against the turbine blades through the first scroll passage is set to be lower than a flow rate of an exhaust gas blown against the turbine blades through the second scroll passage. Let an attack angle of the turbine blades set at an inlet of the turbine blades on the first axial side correspondingly to the first scroll passage be a first attack angle, an attack angle of the turbine blades set at the inlet of the turbine blades on the second axial side correspondingly to the second scroll passage be a second attack angle, and an inflow angle of an exhaust gas flowing into the inlet of the turbine blades with respect to a radial direction set to 0° in a rotating system of coordinates of the turbine wheel be a relative inflow angle, then the first attack angle is set according to a relative inflow angle of an exhaust gas blown against the turbine blades through the first scroll passage, and the second attack angle is set according to a relative inflow angle of an exhaust gas blown against the turbine blades through the second scroll passage.

In the exhaust turbine of the present disclosure, a flow rate of an exhaust gas blown against the turbine blades through the first scroll passage is set to be lower than a flow rate of an exhaust gas blown against the turbine blades through the second scroll passage. Hence, a relative inflow angle of an exhaust gas at an inlet of the turbine blades differs between the first axial side corresponding to the first scroll passage and the second axial side corresponding to the second scroll passage.

In response to the different relative inflow angles, different attack angles are set to the turbine blades on the first axial side and the second axial side according to the respective relative inflow angles of an exhaust gas. That is to say, the first attack angle is set on the first axial side according to a relative inflow angle of an exhaust gas blown against the turbine blades through the first scroll passage, and the second attack angle is set on the second axial side according to a relative inflow angle of an exhaust gas blown against the turbine blades through the second scroll passage. Consequently, the turbine blades can be designed more flexibly in comparison with the related art disclosed in Patent Literature 1 in which the turbine blades are designed according to one of a flow rate of an exhaust gas passing through the first scroll passage and a flow rate of an exhaust gas passing through the second scroll passage when the flow rates are different.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view of a turbine wheel according to a first embodiment of the present disclosure;

FIG. 2 is a sectional view showing a first attack angle and a second attack angle set to turbine blades;

FIG. 3 is a sectional view of an exhaust turbine of the first embodiment;

FIG. 4 is a view showing an overall configuration of an intake and exhaust system of an engine including a turbocharger;

FIGS. 5A and 5B are views used to describe a velocity triangle of an exhaust gas;

FIGS. 6A to 6G are views used to describe a relation of the first attack angle and the second attack angle;

FIG. 7 is a perspective view of turbine blades according to a second embodiment of the present disclosure;

FIG. 8 is a sectional view of an exhaust turbine according to a third embodiment of the present disclosure;

FIG. 9 is a sectional view of an exhaust turbine according to a fourth embodiment of the present disclosure; and

FIG. 10 is a sectional view of an exhaust turbine according to a fifth embodiment of the present disclosure.

### DESCRIPTION OF EMBODIMENTS

Configurations to carry out the present disclosure will be described in detail in embodiments below.

### First Embodiment

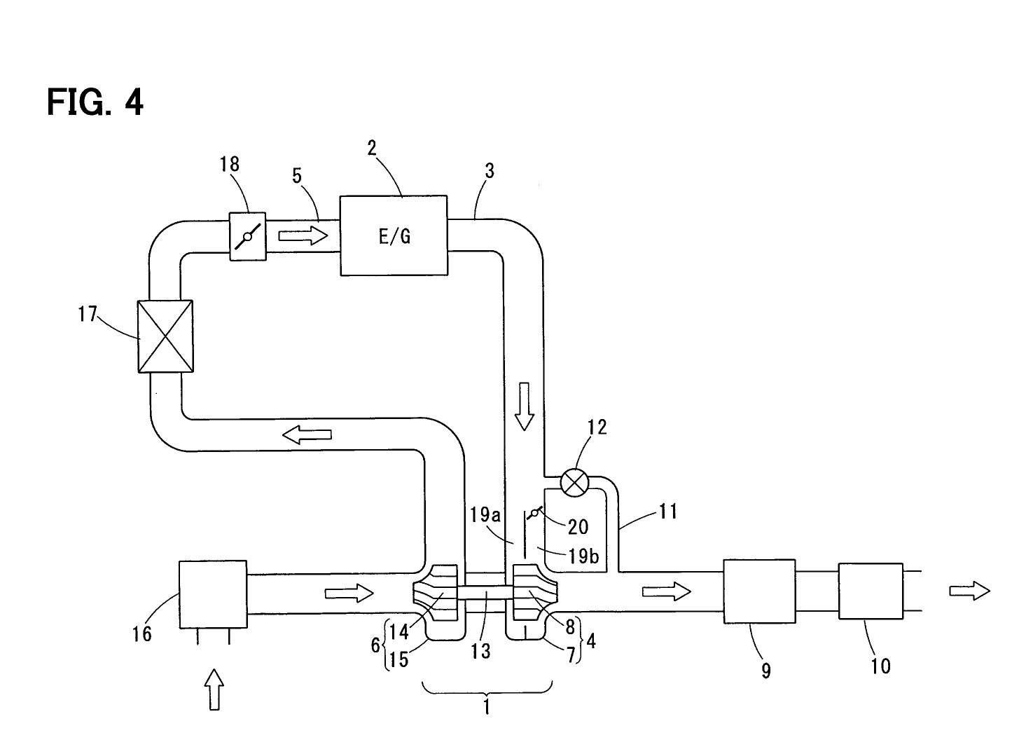

As is shown in FIG. 4, a turbocharger 1 of a first embodiment includes an exhaust turbine 4 disposed downstream of an exhaust manifold 3 in an exhaust path of an engine 2 and an intake air compressor 6 disposed upstream of an intake manifold 5 in an intake path of the engine 2.

The exhaust turbine 4 has a turbine housing 7 into which an exhaust gas is introduced through the exhaust manifold 3, and a turbine wheel 8 which is stored inside the turbine housing 7 and converts kinetic energy of an exhaust gas to a rotary force. The turbine wheel 8 is a radial turbine which lets an exhaust gas flow in from an outer periphery in a radial direction and flow out in an axial direction.

An exhaust purification device 9 removing a toxic substance from an exhaust gas and a muffler 10 functioning as a silencing device are disposed in an exhaust path downstream of the exhaust turbine 4.

The exhaust turbine 4 is provided with a waste gate mechanism capable of adjusting a flow rate of an exhaust gas flowing into the turbine wheel 8. The waste gate mechanism has, for example, an exhaust bypass channel 11 to bypass the turbine wheel 8 by bringing an exhaust upstream side and an exhaust downstream side of the turbine housing 7 into communication and a waste gate valve 12 capable of opening and closing the exhaust bypass channel 11. The waste gate valve 12 opens when a pressure of air (supercharging pressure) forced into the engine 2 rises to or above a constant value. When the waste gate valve 12 opens, a part of an exhaust gas flows downstream of the turbine wheel 8 through the exhaust bypass channel 11. A flow rate of an exhaust gas hitting the turbine wheel 8 is thus decreased. Consequently, a supercharging pressure can be controlled. The waste gate mechanism may be either of a build-in type built in the exhaust turbine 4 by providing the exhaust bypass channel 11 to the turbine housing 7 and installing the waste gate valve 12 to the exhaust bypass channel 11 or of an external type provided independently of the exhaust turbine 4.

The intake air compressor 6 has a compressor wheel 14 connected to the turbine wheel 8 via a turbine shaft 13 and a compressor housing 15 to store the compressor wheel 14 inside. When the compressor wheel 14 rotates in association with rotations of the turbine wheel 8, the intake air compressor 6 compresses air introduced into the compressor housing 15 and forces compressed air into the engine 2.

An air cleaner 16 to filter air to be withdrawn into the engine 2 is provided in an intake path upstream of the intake air compressor 6.

Meanwhile, an intercooler 17 to cool air compressed in the intake air compressor 6 is provided in an intake path downstream of the intake air compressor 6. An electronic throttle device 18 regulating an intake volume is provided downstream of the intercooler 17.

Characteristics of the exhaust turbine 4 of the present disclosure will now be described.

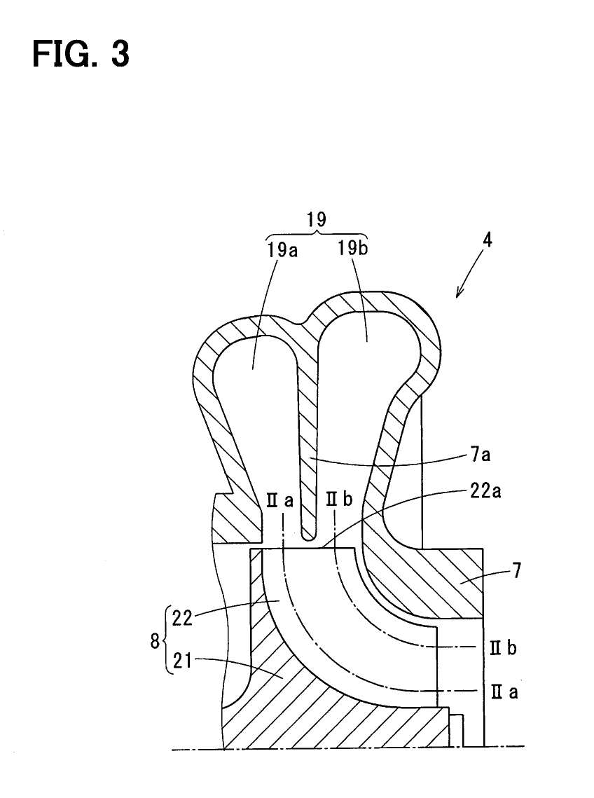

The turbine housing 7 defines a scroll passage 19 of a spiral shape along an outer periphery of the turbine wheel 8. As is shown in FIG. 3, the scroll passage 19 is divided into one (first) side and the other (second) side in an axial direction (right-left direction of FIG. 3) by a partition wall 7a. The first side of the scroll passage 19 divided by the partition wall 7a is referred to as a first scroll passage 19a and the second side is referred to as a second scroll passage 19b. A capacity of the first scroll passage 19a is made smaller than a capacity of the second scroll passage 19b. In the present disclosure, a side (e.g., left side of FIG. 3 which corresponds to one side) in a direction opposite to a direction in which an exhaust gas flows out from the turbine wheel 8 is given as a first axial side and a side (e.g., right side of FIG. 3 which corresponds to other side) in a direction same as the direction in which an exhaust gas flows out is given as a second axial side.

A variable capacity valve 20 (see FIG. 4) making a capacity of the exhaust turbine 4 variable by adjusting a flow rate of an exhaust gas to be introduced into the second scroll passage 19b is provided at an inlet of the second scroll passage 19b. A valve opening degree of the variable capacity valve 20 is controlled according to a running condition of the engine 2. For example, a valve opening degree is controlled to be low when the engine 2 is running at a low speed under a low load and a valve opening degree is controlled to be high when the engine 2 is running at a high speed under a high load. By closing the variable capacity valve 20, the inlet of the second scroll passage 19b is closed to introduce an exhaust gas discharged from the engine 2 into the first scroll passage 19a alone. By opening the variable capacity valve 20, the inlet of the second scroll passage 19b is opened to introduce an exhaust gas into both of the first scroll passage 19a and the second scroll passage 19b. In the present embodiment, the variable capacity valve 20 is a flow-rate adjusting portion.

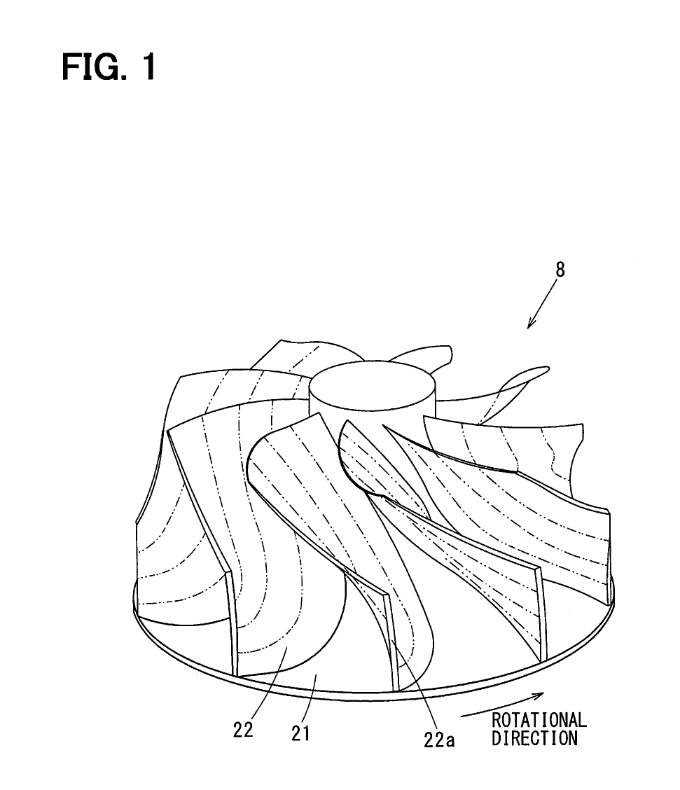

As is shown in FIG. 1, the turbine wheel 8 includes a hub 21 fixed to the turbine shaft 13 (see FIG. 4) and multiple turbine blades 22 provided on a periphery of the hub 21.

The hub 21 is provided in such a manner that a hub radius, which is a height in a radial direction orthogonal to a shaft center of the turbine wheel 8, degrease in a shape of a quadric curve from an inlet side to an outlet side of the turbine wheel 8 for an exhaust gas.

An attack angle of the turbine blades 22 differs between the first axial side corresponding to the first scroll passage 19a and the second axial side corresponding to the second scroll passage 19b.

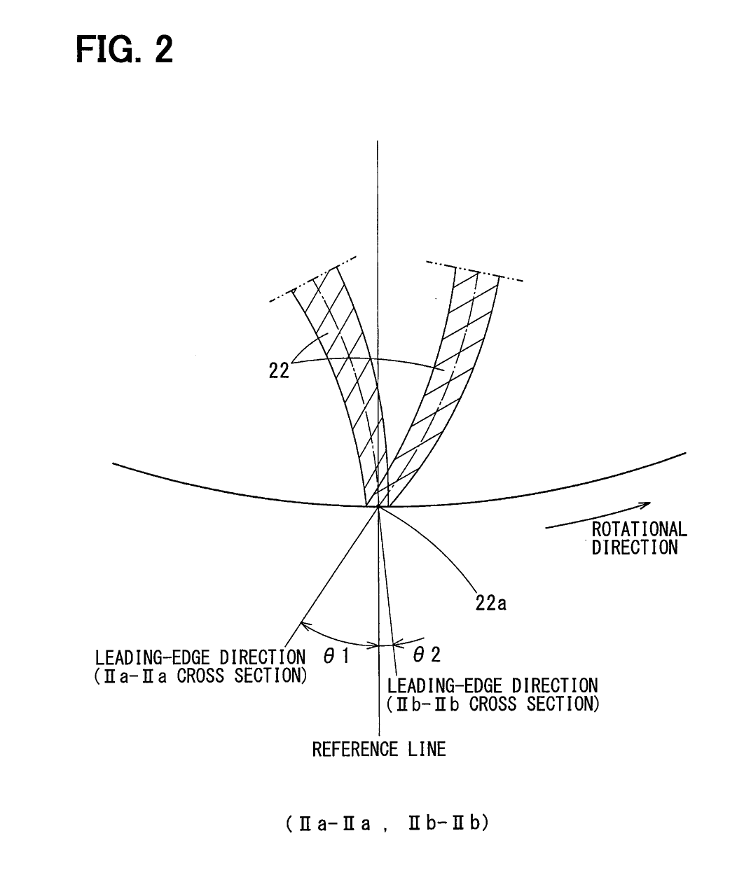

An attack angle is, as is shown in FIG. 2, an angle produced between a leading-edge direction and a reference line. FIG. 2 shows a sectional shape of one turbine blade 22 along a longitudinal direction and corresponds to a cross section taken along the line IIa-IIa and a cross section taken along the line IIb-IIb of FIG. 3. The leading-edge direction is a direction in which a curved center line (line indicated by an alternate long and short dash line of FIG. 2) of the turbine blade 22 in a blade thickness on a cross section along the longitudinal direction is extended radially outward from a blade end. In short, the leading-edge direction is a tangential direction to the center line at the blade end. Hereinafter, the blade end on an inlet side of the turbine blade 22 is referred to as a leading edge 22a. The reference line is a line extending in a radial direction of the turbine wheel 8 by passing the leading edge 22a.

In a description below, an attack angle set on the first axial side is referred to as a first attack angle θ1 and an attack angle set on the second axial side is referred to as a second attack angle θ2.

An attack angle of the turbine blades 22 is set according to a relative inflow angle of an exhaust gas blown against the turbine blades 22. That is to say, the first attack angle θ1 is set according to a relative inflow angle of an exhaust gas blown against the turbine blades 22 from the first scroll passage 19a and the second attack angle θ2 is set according to a relative inflow angle of an exhaust gas blown against the turbine blades 22 from the second scroll passage 19b.

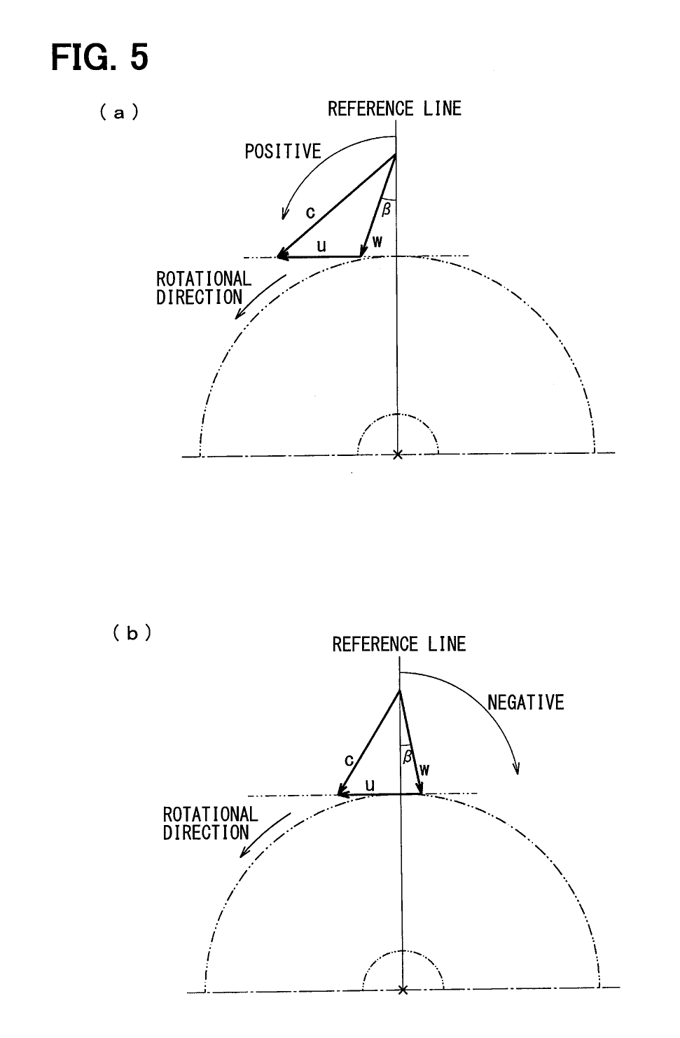

A relative inflow angle of an exhaust gas is an inflow angle of an exhaust gas flowing into the inlet of the turbine blades 22 with respect to a radial direction set to 0° in a rotating system of coordinates of the turbine wheel 8. That is to say, a relative inflow angle is an angle 3 produced between a relative velocity vector and a reference line in a velocity triangle shown in FIGS. 5A and 5B, where c is an absolute velocity of an exhaust gas, u is a circumferential velocity of the turbine blades 22, and w is a relative velocity of an exhaust gas.

An attack angle of the turbine blades 22 with respect to the relative inflow angle β (see FIG. 5A) is a positive angle when the relative velocity w has a vector in a rotational direction (a direction indicated by an arrow of FIG. 5A) of the turbine wheel 8 with respect to the reference line. Meanwhile, an attack angle of the turbine blade 22 with respect to the relative inflow angle β (see FIG. 5B) is a negative angle when the relative velocity w has a vector in an inverse rotational direction of the turbine wheel 8 with respect to the reference line.

In the present disclosure, when a positive angle and a negative angle are compared, the angles are not compared in magnitude and it is defined that an attack angle having a positive angle is larger than an attack angle having a negative angle. For example, when +10 degrees and −30 degrees are compared, it is said that +10 degrees is the larger angle.

The turbine blades 22 of the present disclosure are provided in such a manner that an average value of the first attack angle θ1 is larger than an average value of the second attack angle θ2 in accordance with the definition above.

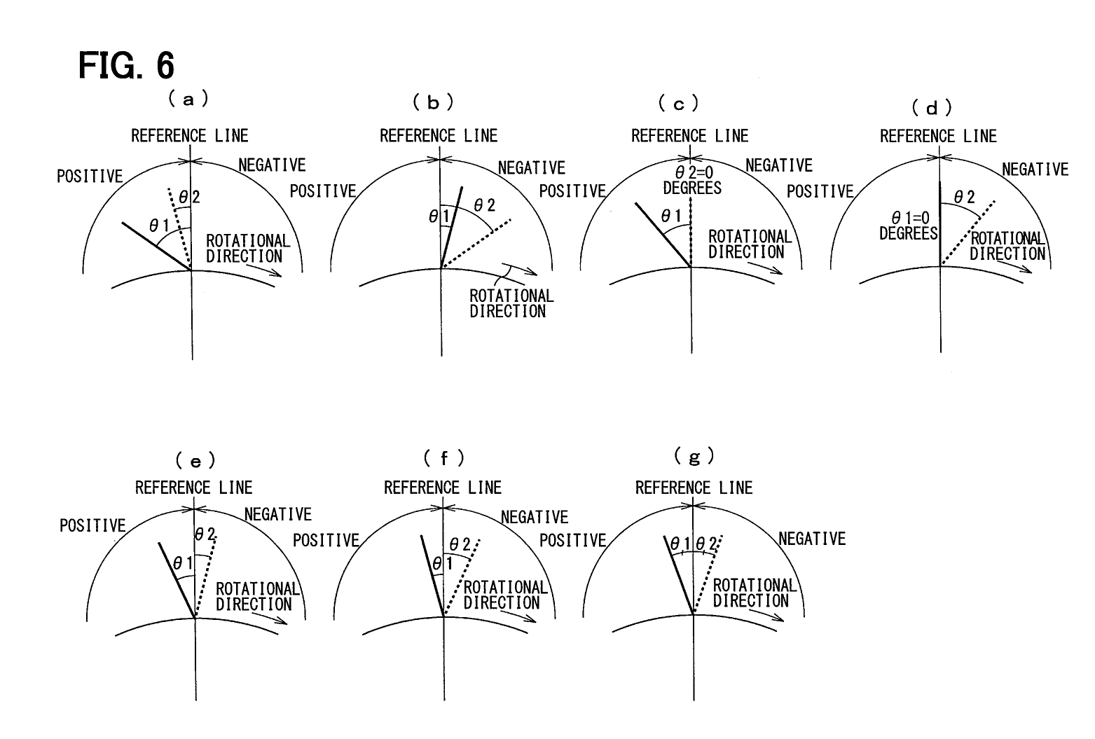

Several cases in which an average value of the first attack angle θ1 is larger than an average value of the second attack angle θ2 will be described with reference to FIGS. 6A to 6G. Given that directions indicated by arrows in FIGS. 6A to 6G are a rotational direction of the turbine wheel 8, then a left side of the reference line in each drawing is a positive angle and a right side of the reference line in each drawing is a negative angle.

FIG. 6A shows a case where both of an average value of the first attack angle θ1 and an average value of the second attack angle θ2 have positive angles.

FIG. 6B shows a case where both of an average value of the first attack angle θ1 and an average value of the second attack angle θ2 have negative angles. An average value of the first attack angle θ1 has a smaller negative angle than an average value of the second attack angle θ2, that is, an average value of the first attack angle θ1 is larger than an average value of the second attack angle θ2.

FIG. 6C shows a case where an average value of the first attack angle θ1 has a positive angle and an average value of the second attack angle θ2 has a zero angle.

FIG. 6D shows a case where an average value of the first attack angle θ1 has a zero angle and an average value of the second attack angle θ2 has a negative angle.

FIGS. 6E to 6G show cases where an average value of the first attack angle θ1 has a positive angle and an average value of the second attack angle θ2 has a negative angle. In each case, an average value of the first attack angle θ1 having a positive angle is larger than an average value of the second attack angle θ2 having a negative angle. In the case of FIG. 6F, when an average value of the first attack angle θ1 and an average value of the second attack angle θ2 are compared in terms of which angle is the larger in magnitude, an average value of the first attack angle θ1 is smaller than an average value of the second attack angle θ2 (θ1<θ2). However, in accordance with the definition above, an average value of the first attack angle θ1 having a positive angle is larger than an average value of the second attack angle θ2 having a negative angle.

An example corresponding to the case of FIG. 6E is shown in FIG. 1 and FIG. 2.

The turbine blades 22 shown in FIG. 1 are provided in such manner that the leading edge 22a is formed in substantially a linear shape on the first axial side (lower side of FIG. 1) and on the second axial side. As is shown in FIG. 2, the first attack angle θ1 having a positive angle with respect to the reference line is set to be larger than the second attack angle θ2 having a negative angle. Arrows shown in FIG. 1 and FIG. 2 indicate a rotational direction of the turbine wheel 8.

The first attack angle θ1 and the second attack angle θ2 do not change sharply between the first axial side and the second axial side and change smoothly. More specifically, an attack angle having a zero angle is present between the first axial side and the second axial side. The first attack angle θ1 is formed on the first axial side of the attack angle having a zero angle so as to increase gradually toward the hub 21 of the leading edge 22a. The second attack angle θ2 is formed on the second axial side so as to decrease gradually (for a negative angle to increase gradually) when distants from the hub 21 of the leading edge 22a. Hence, it can be said that the turbine blades 22 shown in FIG. 1 are provided in such a manner that an average value of the first attack angle θ1 having a positive angle is larger than an average value of the second attack angle θ2 having a negative value.

In the exhaust turbine 4 of the first embodiment, a capacity is formed smaller in the first scroll passage 19a than in the second scroll passage 19b. Hence, a relative inflow angle of an exhaust gas at the inlet of the turbine blades 22 differs between the first axial side corresponding to the first scroll passage 19a and the second axial side corresponding to the second scroll passage 19b. In response to the different relative inflow angles, different attack angles are set to the first axial side and the second axial side of the turbine blades 22 according to the respective relative inflow angles. More specifically, the first attack angle θ1 is set on the first axial side and the second attack angle θ2 is set on the second axial side. An average value of the first attack angle θ1 is set to be larger than an average value of the second attack angle θ2. Accordingly, an attack angle suitable to a relative inflow angle can be set on each of the first axial side and the second axial side. Hence, a flow along the turbine blades 22 increases in comparison with the related art disclosed in Patent Literature 1 and a burble loss in the turbine wheel 8 can be restricted. Consequently, turbine efficiency can be enhanced.

The turbine blades 22 are provided in such a manner that the leading edge 22a is formed in substantially a linear shape on the first axial side and the second axial side and an attack angle is larger on the first axial side corresponding to the first scroll passage 19a than on the second axial side corresponding to the second scroll passage 19b. In short, an average value of the first attack angle θ1 is larger than an average value of the second attack angle θ2. Hence, the turbine blades 22 provided in the manner as above are easier to manufacture than in a case where an average value of the first attack angle θ1 is smaller than an average value of the second attack angle θ2.

An attack angle having a zero angle is present between the first axial side and the second axial side of the turbine blades 22. The first attack angle θ1 is formed so as to increase gradually on the first axial side and the second attack angle θ2 is formed so as to decrease gradually on the second axial side with the attack angle having a zero angle in between. That is to say, the first attack angle θ1 and the second attack angle θ2 change smoothly with the attack angle having a zero angle in between. Hence, the turbine blades 22 causing stress concentration less frequently and easy to manufacture can be presented. In addition, because the attack angles change smoothly, an exhaust gas flows smoothly, which contributes to enhancement of turbine efficiency.

Hereinafter, other embodiments of the present disclosure will be described.

Portions in common with the first embodiment above and configurations same as the configurations of the first embodiment above are labeled with same reference numerals used in the first embodiment above and a description is not repeated.

### Second Embodiment

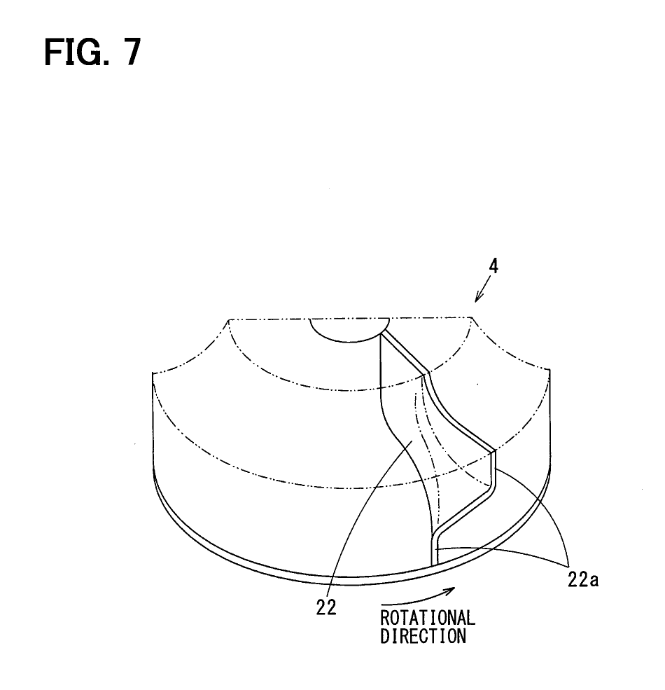

As is shown in FIG. 7, a second embodiment is a case where the leading edge 22a of turbine blades 22 is displaced in a circumferential direction between a first axial side (lower side of FIG. 7) and a second axial side. More specifically, a circumferential position of the leading edge 22a is provided closer to a side in an inverse rotational direction on the first axial side having a first attack angle θ1 than on the second axial side having a second attack angle θ2. It should be noted that, as in the first embodiment above, an average value of the first attack angle θ1 is set to be larger than an average value of the second attack angle θ2.

According to the configuration above, the first attack angle θ1 and the second attack angle θ2 change sharply between the first axial side and the second axial side. Hence, a larger angular difference can be set between an average value of the first attack angle θ1 and an average value of the second attack angle θ2.

### Third Embodiment

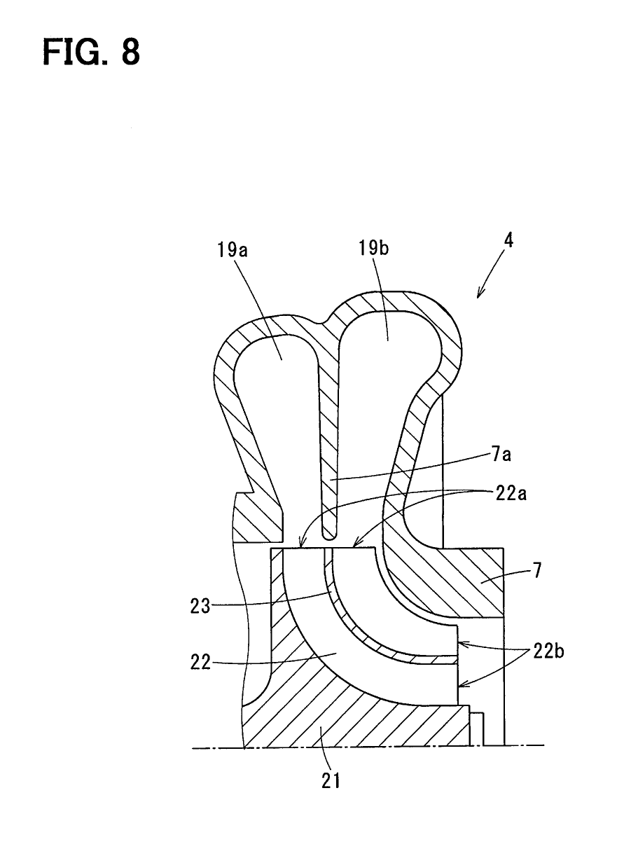

As is shown in FIG. 8, a third embodiment is a case where turbine blades 22 are provided with a partition plate 23.

The partition plate 23 is provided in such a manner that an exhaust gas on a first side blown against the turbine blades 22 through the first scroll passage 19a and an exhaust gas on a second side blown against the turbine blades 22 through the second scroll passage 19b flow independently of each other. That is to say, the partition plate 23 is provided so as to extend from the leading edge 22a to a trailing edge 22b in a space between every two turbine blades 22 provided next to each other in a circumferential direction. The trailing edge 22b is a blade end on an outlet side of the turbine blades 22.

When configured in the manner as above, an exhaust gas on the first side and an exhaust gas on the second side interfere with each other less frequently and diffusion of an exhaust gas from the first side to the second side or vice versa can be restricted. Consequently, turbine efficiency can be enhanced. In addition, an effect by a reinforcing rib for the turbines 22 can be expected by providing the partition plate 23.

### Fourth Embodiment

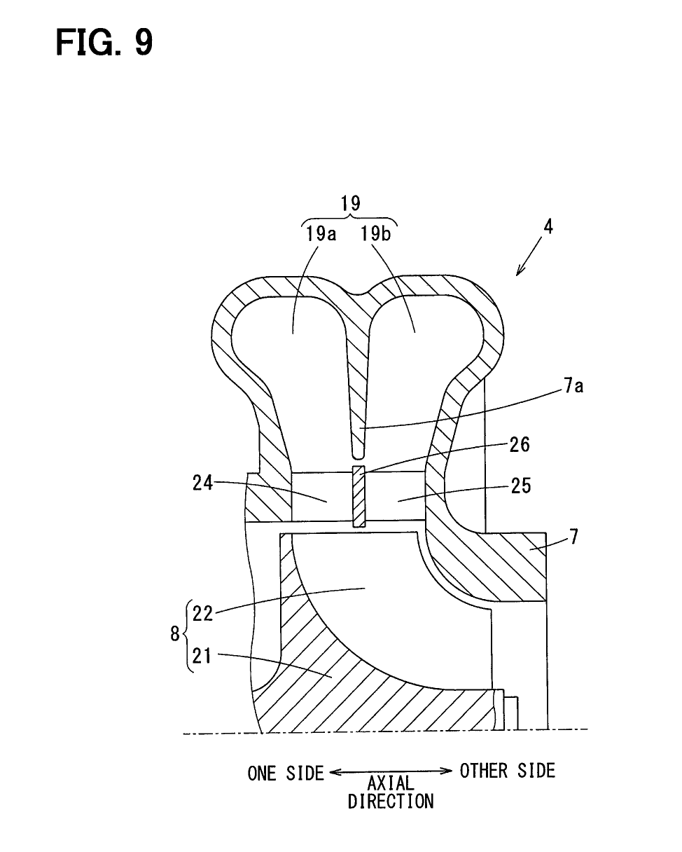

As is shown in FIG. 9, a fourth embodiment is a case where a fixed nozzle is provided at outlets of the first scroll passage 19a and the second scroll passage 19b. An attack angle of the first embodiment or the second embodiment above can be applied to an attack angle θ of the turbine blades 22 of the present embodiment.

The fixed nozzle has a first fixed nozzle 24 provided at an outlet of the first scroll passage 19a and a second fixed nozzle 25 provided at an outlet of the second scroll passage 19b. A nozzle plate 26 is interposed between the first fixed nozzle 24 and the second fixed nozzle 25. That is to say, the first fixed nozzle 24 is disposed on a first axial side and the second fixed nozzle 25 is disposed on a second axial side with the nozzle plate 26 in between. The nozzle plate 26 isolates the first fixed nozzle 24 from the second fixed nozzle 25 in an axial direction for an exhaust gas passing through the first fixed nozzle 24 and an exhaust gas passing through the second fixed nozzle 25 to flow independently of each other.

In each of the first fixed nozzle 24 and the second fixed nozzle 25, multiple nozzle vanes are disposed at predetermined intervals in a circumferential direction. A throat area of the first fixed nozzle 24 is formed smaller than a throat area of the second fixed nozzle 25. A throat area is a minimum passage area formed between two nozzle vanes aligned next to each other in the circumferential direction. For example, a throat area can be made smaller by providing a larger number of nozzle vanes to the first fixed nozzle 24 than to the second fixed nozzle 25 or by radially tilting nozzle vanes at a larger angle in the first fixed nozzle 24 than in the second fixed nozzle 25. When configured in the manner as above, a flow rate of an exhaust gas passing through the first fixed nozzle 24 becomes lower than a flow rate of an exhaust gas passing through the second fixed nozzle 25.

According to the configuration above, flow rates of an exhaust gas is reduced at the first fixed nozzle 24 and the second fixed nozzle 25. Hence, it is not necessary to make a capacity of the first scroll passage 19a smaller than a capacity of the second scroll passage 19b. In other words, a capacity of the first scroll passage 19a and a capacity of the second scroll passage 19b can be equal. Accordingly, in comparison with a case where a capacity of the first scroll passage 19a is made smaller, a frictional loss due to a surface roughness of the turbine housing 7 can be reduced. Hence, turbine efficiency can be enhanced.

In addition, the nozzle plate 26 is interposed between the first fixed nozzle 24 and the second fixed nozzle 25. Hence, an exhaust gas passing through the first fixed nozzle 24 and an exhaust gas passing through the second fixed nozzle 25 do not interfere with each other. Consequently, flows independent of each other can be formed by the first fixed nozzle 24 and the second fixed nozzle 25.

### Fifth Embodiment

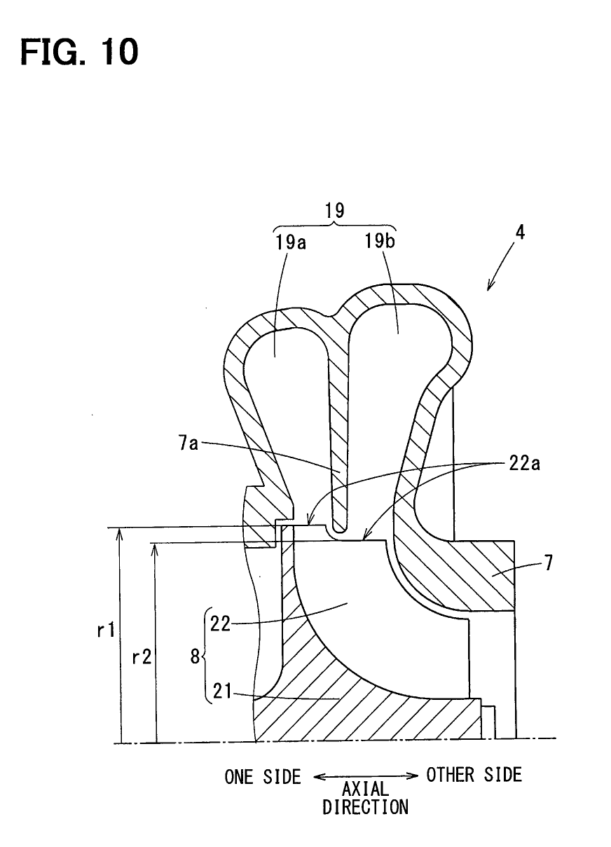

A fifth embodiment is a case where a turbine radius of the turbine blades 22 differs between a portion corresponding to the first scroll passage 19a and a portion corresponding to the second scroll passage 19b. A turbine radius means a distance from a shaft center of the turbine wheel 8 indicated by an alternate long and short dash line in FIG. 10 to the leading edge 22a of the turbine blades 22.

A specific configuration of the fifth embodiment is shown in FIG. 10.

The turbine blades 22 are provided in such a manner that a turbine radius is large on a first axial side corresponding to the first scroll passage 19a and small on a second axial side corresponding to the second scroll passage 19b. That is to say, let a turbine radius of a portion corresponding to the first scroll passage 19a be a first radius r1 and a turbine radius of a portion corresponding to the second scroll passage 19b be a second radius r2. Then, as is shown in FIG. 10, a relation that the first radius r1 is larger than the second radius r2 is established.

When configured in the manner as above, relative inflow angles of an exhaust gas at an inlet of the turbine blades 22 on the first axial side corresponding to the first scroll passage 19a and on the second axial side corresponding to the second scroll passage 19b can be close to each other. Hence, an occurrence of turbulence or choking can be restricted further than in the respective embodiments above and a burble loss in the turbine wheel 8 can be restricted. Consequently, turbine efficiency can be increased.

### Modification Examples

In the first embodiment above, the first scroll passage 19a is defined on the first axial side and the second scroll passage 19b is defined on the second axial side. However, the present disclosure is also applicable to a configuration in which locations of the first scroll passage 19a and the second scroll passage 19b are reversed. In such a case, the second attack angle θ2 is set on the first axial side of the turbine blades 22 and the first attack angle θ1 is set on the second axial side. It should be noted, however, that, as in the first embodiment above, an average value of the first attack angle θ1 is set to be larger than an average value of the second attack angle θ2.

The present disclosure is also applicable to a case where the first scroll passage 19a and the second scroll passage 19b have a same size and a same positional relation. In such a case, a difference of inflow angles arising from a production tolerance can be corrected.

In the fourth embodiment above, a throat area is made smaller in the first fixed nozzle 24 disposed on the first axial side than in the second fixed nozzle 25 disposed on the second axial side. However, the present disclosure is also applicable to a configuration in which a throat area is made smaller in the second fixed nozzle 25 than in the first fixed nozzle 24. In such a case, a first attack angle θ1 is set on the second axial side of the turbine blades 22 corresponding to the second fixed nozzle 25 having a small throat area and a second attack angle θ2 is set on the first axial side corresponding to the first fixed nozzle 24 having a large throat area. As in the first embodiment above, an average value of the first attack angle θ1 is set to be larger than an average value of the second attack angle θ2.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. An exhaust turbine for a turbocharger, comprising:
a turbine wheel having a plurality of turbine blades on a periphery of a hub fixed to a shaft; and
a turbine housing defining a scroll passage on an outer periphery of the turbine wheel, the turbine wheel rotating when an exhaust gas discharged from an internal combustion engine is blown against the turbine blades through the scroll passage, wherein
the turbine housing divides the scroll passage into a first axial side and a second axial side to provide a first scroll passage on the first side and a second scroll passage on the second side in such a manner that a flow rate of an exhaust gas blown against the turbine blades through the first scroll passage is set to be lower than a flow rate of an exhaust gas blown against the turbine blades through the second scroll passage,
let an attack angle of the turbine blades set at an inlet of the turbine blades on the first axial side correspondingly to the first scroll passage be a first attack angle an attack angle of the turbine blades set at the inlet of the turbine blades on the second axial side correspondingly to the second scroll passage be a second attack angle, and an inflow angle of an exhaust gas flowing into the inlet of the turbine blades with respect to a radial direction set to 0° in a rotating system of coordinates of the turbine wheel be a relative inflow angle, then the first attack angle is set according to a relative inflow angle of an exhaust gas blown against the turbine blades through the first scroll passage, and the second attack angle is set according to a relative inflow angle of an exhaust gas blown against the turbine blades through the second scroll passage,
a reference line is set in a radial direction of the turbine wheel, given that an attack angle of the turbine blades set according to the relative inflow angle is a positive angle when a relative velocity of an exhaust gas at the inlet of the turbine blades has a vector in a rotational direction of the turbine wheel with respect to the reference line, and an attack angle of the turbine blades set according to the relative inflow angle is a negative value when a relative velocity of an exhaust gas has a vector in an inverse rotational direction of the turbine wheel with respect to the reference line, then an average value of the first attack angle is larger than an average value of the second attack angle.

2. An exhaust turbine for a turbocharger, comprising:
a turbine wheel having a plurality of turbine blades on a periphery of a hub fixed to a shaft; and
a turbine housing defining a scroll passage on an outer periphery of the turbine wheel, the turbine wheel rotating when an exhaust gas discharged from an internal combustion engine is blown against the turbine blades through the scroll passage, wherein
the turbine housing divides the scroll passage into a first axial side and a second axial side to provide a first scroll passage on the first side and a second scroll passage on the second side in such a manner that a flow rate of an exhaust gas blown against the turbine blades through the first scroll passage is set to be lower than a flow rate of an exhaust gas blown against the turbine blades through the second scroll passage,
let an attack angle of the turbine blades set at an inlet of the turbine blades on the first axial side correspondingly to the first scroll passage be a first attack angle, an attack angle of the turbine blades set at the inlet of the turbine blades on the second axial side correspondingly to the second scroll passage be a second attack angle, and an inflow angle of an exhaust gas flowing into the inlet of the turbine blades with respect to a radial direction set to 0° in a rotating system of coordinates of the turbine wheel be a relative inflow angle, then the first attack angle is set according to a relative inflow angle of an exhaust gas blown against the turbine blades through the first scroll passage, and the second attack angle is set according to a relative inflow angle of an exhaust gas blown against the turbine blades through the second scroll passage, and
an average value of the first attack angle set to the turbine blades has a positive angle and an average value of the second attack angle set to the turbine blades has a negative angle.

3. The exhaust turbine for a turbocharger according to claim 1, wherein
let a blade end of the turbine blades against which an exhaust gas is blown be a leading edge, then the leading edge is provided in a linear shape and the attack angles change smoothly between the first axial side and the second axial side.

4. The exhaust turbine for a turbocharger according to claim 1, wherein
let a blade end of the turbine blades against which an exhaust gas is blown be a leading edge, then a circumferential position of the leading edge differs between the first axial side and the second axial side.

5. The exhaust turbine for a turbocharger according to claim 1, wherein
a partition plate is provided between every two turbine blades provided next to each other in a circumferential direction for a flow of an exhaust gas blown against the turbine blades through the first scroll passage and a flow of an exhaust gas blown against the turbine blades through the second scroll passage to be independent of each other.

6. The exhaust turbine for a turbocharger according to claim 1, wherein
let a side in a direction opposite to a direction in which an exhaust gas flows out from the turbine wheel be the first axial side, and a side in a direction same as the direction in which an exhaust gas flows out be the second axial side, then the first scroll passage defined on the first axial side has a smaller capacity than the second scroll passage defined on the second axial side.

7. The exhaust turbine for a turbocharger according to claim 1, further comprising:
a first fixed nozzle to reduce a flow rate of an exhaust gas is disposed at an outlet of the first scroll passage defined on the first axial side; and a second fixed nozzle to reduce a flow rate of an exhaust gas is disposed at an outlet of the second scroll passage defined on the second axial side, when let a side in a direction opposite to a direction in which an exhaust gas flows out from the turbine wheel be the first axial side and a side in a direction same as the direction in which an exhaust gas flows out be the second axial side, wherein
a throat area is smaller in the first fixed nozzle than in the second fixed nozzle.

8. The exhaust turbine for a turbocharger according to claim 1, wherein
let the blade end of the turbine blades against which an exhaust gas is blown be the leading edge and a distance from a shaft center of the turbine wheel to the leading edge of the turbine blades be a turbine radius, then the turbine radius of the turbine blades on the first axial side corresponding to the first scroll passage is made large and the turbine radius of the turbine blades on the second axial side corresponding to the second scroll passage is made small.

9. The exhaust turbine for a turbocharger according to claim 1, further comprising:
a flow-rate adjusting portion capable of adjusting a flow rate of an exhaust gas to be introduced into the second scroll passage.

10. The exhaust turbine for a turbocharger according to claim 2, wherein
let a blade end of the turbine blades against which an exhaust gas is blown be a leading edge, then the leading edge is provided in a linear shape and the attack angles change smoothly between the first axial side and the second axial side.

11. The exhaust turbine for a turbocharger according to claim 2, wherein
let a blade end of the turbine blades against which an exhaust gas is blown be a leading edge, then a circumferential position of the leading edge differs between the first axial side and the second axial side.

12. The exhaust turbine for a turbocharger according to claim 2, wherein
a partition plate is provided between every two turbine blades provided next to each other in a circumferential direction for a flow of an exhaust gas blown against the turbine blades through the first scroll passage and a flow of an exhaust gas blown against the turbine blades through the second scroll passage to be independent of each other.

13. The exhaust turbine for a turbocharger according to claim 2, wherein
let a side in a direction opposite to a direction in which an exhaust gas flows out from the turbine wheel be the first axial side, and a side in a direction same as the direction in which an exhaust gas flows out be the second axial side, then the first scroll passage defined on the first axial side has a smaller capacity than the second scroll passage defined on the second axial side.

14. The exhaust turbine for a turbocharger according to claim 2, further comprising:
a first fixed nozzle to reduce a flow rate of an exhaust gas is disposed at an outlet of the first scroll passage defined on the first axial side; and a second fixed nozzle to reduce a flow rate of an exhaust gas is disposed at an outlet of the second scroll passage defined on the second axial side, when let a side in a direction opposite to a direction in which an exhaust gas flows out from the turbine wheel be the first axial side and a side in a direction same as the direction in which an exhaust gas flows out be the second axial side, wherein
a throat area is smaller in the first fixed nozzle than in the second fixed nozzle.

15. The exhaust turbine for a turbocharger according to claim 2, wherein
let the blade end of the turbine blades against which an exhaust gas is blown be the leading edge and a distance from a shaft center of the turbine wheel to the leading edge of the turbine blades be a turbine radius, then the turbine radius of the turbine blades on the first axial side corresponding to the first scroll passage is made large and the turbine radius of the turbine blades on the second axial side corresponding to the second scroll passage is made small.

16. The exhaust turbine for a turbocharger according to claim 2, further comprising:
a flow-rate adjusting portion capable of adjusting a flow rate of an exhaust gas to be introduced into the second scroll passage.
